(19) United States
(12) Patent Application Publication
(10) Pub. No.: US 2008/0124163 A1
(43) Pub. Date: May 29, 2008

(54) PRINTER APPARATUS AND METHOD FOR CORRECTING POSITION OF SHEET

(75) Inventors: Toshiyasu Morimoto, Kanagawa (JP); Tomohiro Maekawa, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/942,447

(22) Filed: Nov. 19, 2007

(30) Foreign Application Priority Data
Nov. 24, 2006 (JP) 2006-317651

(51) Int. Cl. B41J 13/26

(52) U.S. Cl. 400/630

(57) ABSTRACT

A printer apparatus includes: transfer means for transferring a sheet; printing means for printing on the sheet; correcting means for correcting the position of the sheet to be transferred to the printing means, the correcting means having a reference plate and lever guide plates each having a supporting member and an urging member; moving means for moving the reference plate and the lever guide plates toward/away from each other; control means for controlling the moving means; and transfer position detecting means for detecting that the sheet has been transferred to a corrected position by the correcting means, wherein the control means changes the space between the reference plate and the lever guide plates, which support both side edges of the sheet transferred to the corrected position in a range equal to or shorter than the width of the sheet.

### CROSS REFERENCES TO RELATED APPLICATIONS

The present invention contains subject matter related to Japanese Patent Applications JP 2006-317651 filed in the Japanese Patent Office on Nov. 24, 2006, the entire contents of which being incorporated herein by reference.

### BACKGROUND OF THE INVENTION

1. Field of the Invention

The present invention relates to means for transferring a sheet and a printer apparatus including printing means on a sheet and, in particular, to a printer apparatus including correcting means for correcting the position of a sheet before transferring the sheet to a printing block.

2. Description of the Related Art

A printer apparatus that performs printing on a printing sheet such as printing paper and a printing film by thermal transfer or laser has been provided from the past. Such a printer apparatus generally includes a sheet storage section that may store a stack of multiple printing sheets, a pickup section that takes out printing sheets stored in the sheet storage section one by one, a transfer section that transfers the printing sheet taken out by the pickup section, a printing section that performs printing on the printing sheet transferred by the transfer section, and a sheet ejecting section that ejects the printing sheet printed by the printing section, and these components are deployed within a cabinet. This kind of printer apparatus may be of a horizontal layout type that can be placed horizontally such that a printing sheet can be transferred from the sheet storage section to the sheet ejecting section with the sheet surface facing vertically or of a horizontal/vertical type that can be placed vertically such that a printing sheet can be transferred from the sheet storage section to the sheet ejecting section with the sheet surface facing horizontally, in addition to the horizontal type.

In an examination by computer tomography (CT) or an examination by magnetic resonance imaging (MRI) within a hospital, a printer apparatus that prints a shot image of the horizontal/vertical type may be provided in association with a shooting apparatus or in association with a computer in a consulting room even in a case where a large area is not available therefor, which can improve the efficiency of medical operations.

By the way, a printer apparatus in the past may possibly cause a displacement of transfer positions of printing sheets against the printing section since the printing sheets are sequentially fed by multiple transfer rollers in a process of taking out a printing sheet by the pickup section from the sheet storage section and transferring the printing sheet to the printing section by the transfer section. The displacement of a printing sheet prevents the upper side edge of the printing sheet from facing right against the head of the printing section, and the printing sheet may be transferred diagonally against the head.

Thus, the occurrence of such a displacement may cause a printing failure such as preventing the printing block from printing an image on a part of the sheet, resulting in a lack of an image, and causing a displacement in direction of an image on the printing sheet.

On the other hand, in order to avoid a printing failure such as diagonal printing, the position of a printing sheet is typically corrected to one position against the head of the printing section in a printing apparatus including a correcting function that corrects the attitude of a printing sheet before image printing. Thus, a burr caused at an outer side edge of printing sheets repetitively has friction against the head, which may cause a damage on the head surface or deposits of dust and may cause a strip appearing on a printed image. As a result, the printing quality may be possibly decreased.

An example of the related art include JP-A-2003-154717 (Patent Document 1).

### SUMMARY OF THE INVENTION

Accordingly, it is desirable to provide a printer apparatus and a method for correcting the position of a sheet, which can prevent the displacement of a printing sheet, prevent a problem caused by an outer edge of printing sheets repetitively having friction against one same position of a head and print an image properly.

According to an embodiment of the invention, there is provided a printer apparatus including transfer means for transferring a sheet, printing means for printing on the sheet, correcting means for correcting the position of the sheet to be transferred to the printing means, the correcting means having a reference plate functioning as a reference for correcting the position of the sheet and supporting one side edge of the sheet, and lever guide plates facing against the reference plate and each having a supporting member rotatably supported substantially in orthogonal to the direction of transfer of the sheet and in point-contact with the other side edge of the sheet and an urging member urging the supporting member to the reference plate side, moving means for moving the reference plate and the lever guide plate toward/away from each other, control means for controlling the moving means, and transfer position detecting means for detecting that the sheet has been transferred to a corrected position by the correcting means, wherein the control means changes the space between the reference plate and the lever guide plates, which support both side edges of the sheet transferred to the corrected position in a range equal to or shorter than the width of the sheet.

According to another embodiment of the invention, there is provided a method for correcting the position of a sheet in a printer apparatus including transfer means for transferring a sheet, printing means for printing on the sheet, correcting means for correcting the position of the sheet to be transferred to the printing means, the correcting means having a reference plate functioning as a reference for correcting the position of the sheet and supporting one side edge of the sheet, and lever guide plates facing against the reference plate and each having a supporting member rotatably supported substantially in orthogonal to the direction of transfer of the sheet and in point-contact with the other side edge of the sheet and an urging member urging the supporting member to the reference plate side, moving means for moving the reference plate and the lever guide plates toward/away from each other, control means for controlling the moving means, and transfer position detecting means for detecting that the sheet has been transferred to a corrected position by the correcting means, wherein the control means controls the moving means to change the space between the reference plate and the lever guide plates, which support both side edges of the sheet transferred to the corrected position in a range equal to or shorter than the width of the sheet.

According to the embodiments of the invention, the positions of sheets in multiple sizes can be corrected since the space between the reference plate and the lever guide plates is adjustable by the moving means during a positional correction operation on the sheets. The correcting means can perform optimum positional correction on a transferred sheet also in a positional correction operation on sheets by adjusting the correction position with reference to the position of the reference plate and the pressing force by the supporting members of the lever guide plates in accordance with different factors such as the size of the sheet and the attitude where the apparatus body is placed.

### BRIEF DESCRIPTION OF THE DRAWINGS

FIG. 1 is a perspective view showing a printer apparatus according to an embodiment of the present invention;

FIG. 2 is a perspective view showing a printer apparatus with the tray pulled out;

FIG. 3 is a perspective view showing a vertically placed printer apparatus;

FIG. 4 is a conceptual diagram showing a construction of a printer apparatus according to an embodiment of the invention and a transfer path for a printing sheet;

FIG. 5 is a perspective view showing an apparatus body with a position correcting section shown;

FIG. 6 is a perspective view showing the position correcting section;

FIG. 7 is a perspective view showing the position correcting section without a protective cover and a middle pickup roller;

FIG. 8 is a perspective view showing a reference plate, lever guide plates and a moving mechanism;

FIG. 9 is a perspective view showing the lever guide plate;

FIG. 10 is a perspective view showing a position for transferring a printing sheet to the position correcting section;

FIGS. 11A and 11B are perspective views showing the position correcting section with the reference plate and the lever guide plates moved toward and away from each other;

FIG. 12 is a functional block diagram of the printer apparatus;

FIG. 13 is a flowchart of a positional correction operation;

FIGS. 14A to 14D are perspective views showing steps of the positional correction operation on a printing sheet;

FIG. 15 is a plan view showing a state where the transfer position of a printing sheet is corrected by a loading section;

FIG. 16 is a perspective view showing steps of the position correcting operation on a printing sheet;

FIGS. 17A and 17B are plan views showing a state that the correction position of a printing sheet is moved by changing the approaching distance between the reference plate and the lever guide plates; and

FIG. 18 is an elevation view showing a vertically placed printer apparatus;

FIG. 19 is a flowchart for another positional correction operation.

### DESCRIPTION OF THE PREFERRED EMBODIMENTS

With reference to drawings, a printer apparatus and a method for correcting the position of a sheet according to embodiments of the invention will be described in detail below. A printer apparatus according to an embodiment of the invention may be a thermal head printer (which will be called printer apparatus 1, hereinafter) that may be used in medical fields and receives image data obtained by an image obtaining apparatus such as an MRI (Magnetic Resonance Imaging), a CR (Computer Radiography), a CT (Computerized Tomography) and an ultrasonic shooting apparatus and prints the image data on a heat-sensitive printing medium by thermal transfer by using a thermal head.

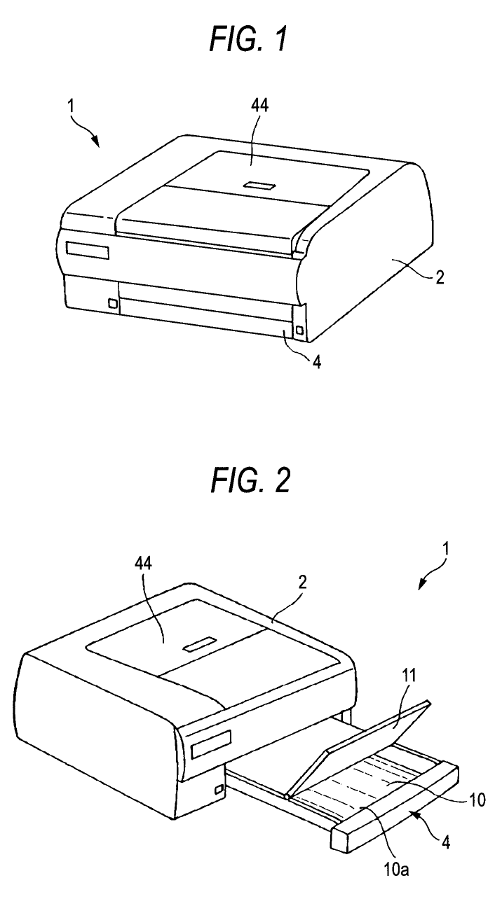

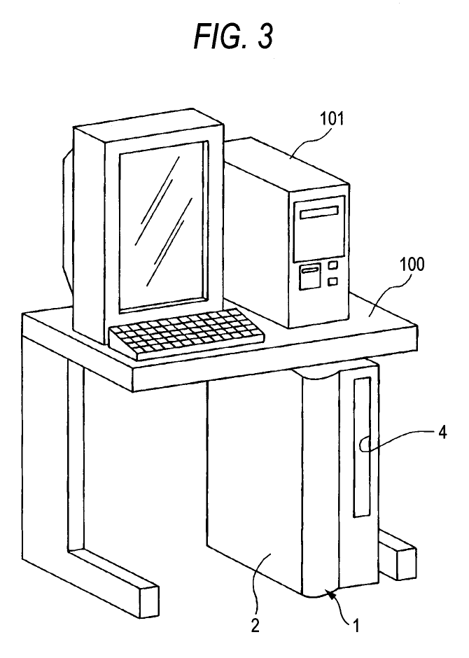

As shown in FIGS. 1 and 2, the printer apparatus 1 is a horizontal/vertical type of printer that can be placed horizontally so that a printing sheet can be transferred with the sheet surface facing vertically and can be placed vertically so that a printing sheet can be transferred with the sheet surface facing horizontally. Thus, the printer apparatus 1 can be placed in accordance with the space for the installation place, which can increase the flexibility of the installation place. In a case of the vertical installation, the printer apparatus 1 can be installed below a host machine 101 such as a personal computer installed on a personal computer table 100, as shown in FIG. 3.

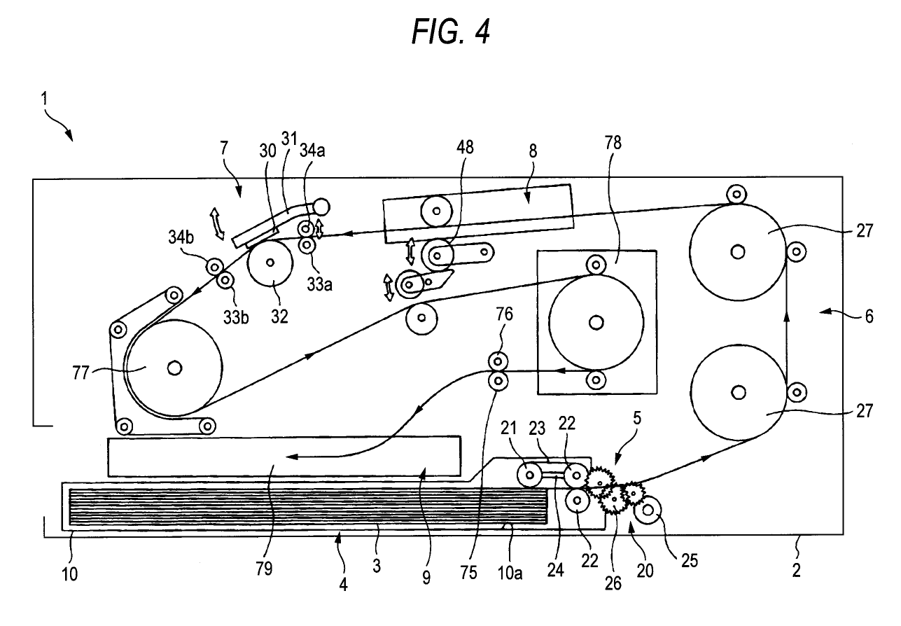

The printer apparatus 1 includes, as shown in FIG. 4, an apparatus body 2 having a substantially rectangular form, and a tray 4 is attached to the front surface of the apparatus body 2. A stack of multiple printing sheets 3, each of which is a printing medium, is to be stored on the tray 4. The printer apparatus 1 further includes, within the apparatus body 2, a pickup section 5, a transfer section 6, a printing section 7, a position correcting section 8 and an ejecting section 9. The pickup section 5 takes out the printing sheets 3 stored on the tray 4 one by one. The transfer section 6 transfers the taken out printing sheet 3 into the apparatus body 2. The printing section 7 prints on the printing sheet 3 transferred to a predetermined position of the apparatus body 2. The position correcting section 8 corrects the position of the printing sheet 3 before transferred to the printing section 7. The ejecting section 9 ejects the printed printing sheets 3.

Now, the printing sheet 3 on which an image is to be printed will be described. The printing sheet 3 is a piece of heat-sensitive recording paper having a heat-sensitive layer formed by coating a heat-sensitive material on a supporting body. The supporting body may contain an elastic sheet material having flexibility, such as polyethylene terephthalate (PET). The heat-sensitive layer to be coated on the supporting member may contain poly(vinyl alcohol), pigments, a color developing agent and/or additives, for example. The printing sheets 3 may have multiple sizes (such as 14×17, 11×14, 10×12, 8×10 (in inches)) and are used differently according to the application. Multiple trays 4 for different sizes may be attached to the apparatus body 2.

The unused printing sheets 3 are stored in a moisture-proof package. The package is opened to use the printing sheet or sheets 3, and the whole package may be stored within the tray 4. Each of the printing sheets 3 is taken out by the pickup section 5 from the inside of the opened package. An IC tag recording information such as the size of the printing sheet 3 is attached to a predetermined position of the package. The information such as the size of the printing sheet 3 is read by a reading section provided within the tray 4 to the printer apparatus 1. With reference to the information in the IC tag attached to the package, the printer apparatus 1 controls the approaching distance between a reference plate 41 and lever guide plates 42 of a position correcting section 8, which will be described later.

The tray 4 for storing the printing sheets 3 is removably attached to the apparatus body 2, as shown in FIG. 2, and is pulled out from the apparatus body 2 to store the printing sheet 3 and is attached to the apparatus body 2 again after storing the printing sheets 3. The tray 4 includes a tray body 10 and a cover 11. The tray body 10 has a flat box shape, which is long in the front-to-back direction, and is open upward. The cover 11 blocks the opening of the tray body 10.

The pickup section 5 includes, as shown in FIG. 4, a takeout mechanism 20 placed at the rear end of the tray 4 for taking out the printing sheets 3 stored on the tray 4 one by one.

The takeout mechanism 20 has a pickup roller 21. The pickup roller 21 is connected, through a timing belt 23, with one separating roller 22 of a pair of separating rollers 22 and 22 supported at the back of the pickup roller 21.

A connecting member 24 is provided for connecting the rotational axis of the pickup roller 21 and the rotational axis of the separating roller 22, which are connected by the timing belt 23. The connecting member 24 is urged toward a bottom surface part 10a of the tray body 10 by latching with the one end of an urging spring the other end of which is latched with the bottom surface part 10a side of the tray body 10. Thus, the pickup roller 21 is pressed against the first one of the printing sheets 3 piled and stored on the tray 4. The pickup roller 21 is abutted to the substantial center of the printing sheets 3 in the width direction.

A pickup motor 25 is placed behind the separating rollers 22 and 22, and a gear group 26 is supported between the separating rollers 22 and 22 and the pickup motor 25.

When the pickup motor 25 is rotated in the takeout mechanism 20, the driving force is transmitted sequentially to the gear group 26, separating rollers 22 and pickup roller 21. The pickup roller 21 is rotated, and the printing sheet 3 is taken out from the tray 4. The taken out printing sheet 3 is fed to the transfer section 6 through between the separating rollers 22 and 22.

The transfer section 6 includes multiple transfer rollers 27, the detail description of which will be omitted herein, and a motor (not shown) that drives the transfer rollers 27 and transfers the printing sheet 3 to the position correcting section 8.

The printing section 7 includes a thermal head 30 and a head driving mechanism 31 that drives the thermal head 30. The thermal head 30 has a printing head on the head supporting body. The printing sheet 3 is heated by the printing head, and an image is transferred thereto. The printing head has a line of multiple heat generating elements, and the amount of current carrying is controlled according to the tone level of the multiple heat generating elements, and the thermal energy generated at the time is used to print on the printing sheet 3.

The thermal head 30 is placed to face against a platen roller 32 and can be moved toward or away from the platen roller 32 by the head driving mechanism 31. The head driving mechanism 31 moves the thermal head 30 toward or away from the platen roller 32 and adjusts the head pressure against the printing sheet 3 and platen roller 32.

The printing section 7 has a capstan roller 33a and a pinch roller 34a that receive the printing sheet 3 transferred by the transfer section 6 and transfer the printing sheet 3 through between the thermal head 30 and the platen roller 32. The printing section 7 further has a capstan roller 33b and a pinch roller 34b that pass the printed printing sheet 3 from the printing section 7 to the ejecting section 9. Among them, the capstan roller 33a between the printing section 7 and the position correcting section 8 has a hoisting and lowering mechanism, not shown, and is laid by at the bottom during the position correction on the printing sheet 3 by the position correcting section 8 and, after the correction, is hoisted and holds the positionally corrected printing sheet 3 together with the pinch roller 34a.

Next, the position correcting section 8 will be described that corrects a displacement of the printing sheet 3 in a process of transferring the printing sheet 3 to the printing section 7. The position correcting section 8 corrects the printing sheet 3 to a proper position in the printing section 7 by correcting a displacement of the printing sheet 3, that is, to the direction in which the upper side edge of the printing sheet 3 faces right to the thermal head 30 of the printing section 7.

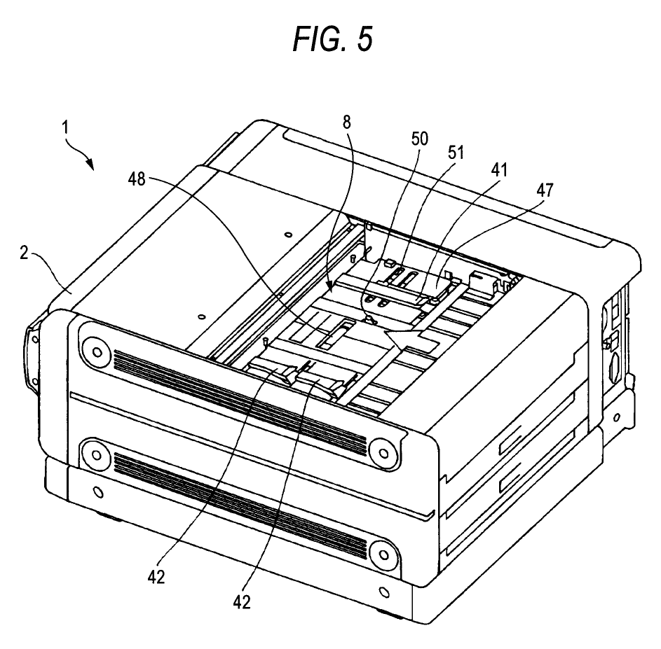

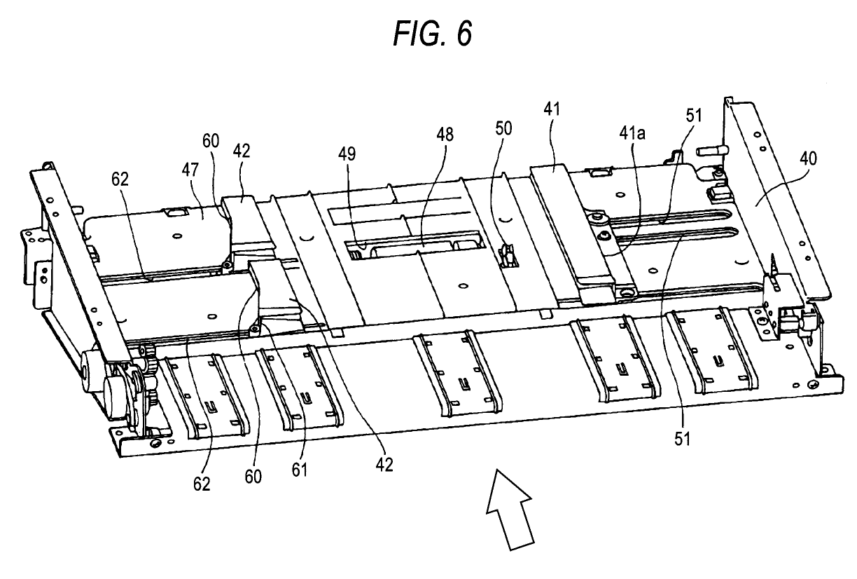

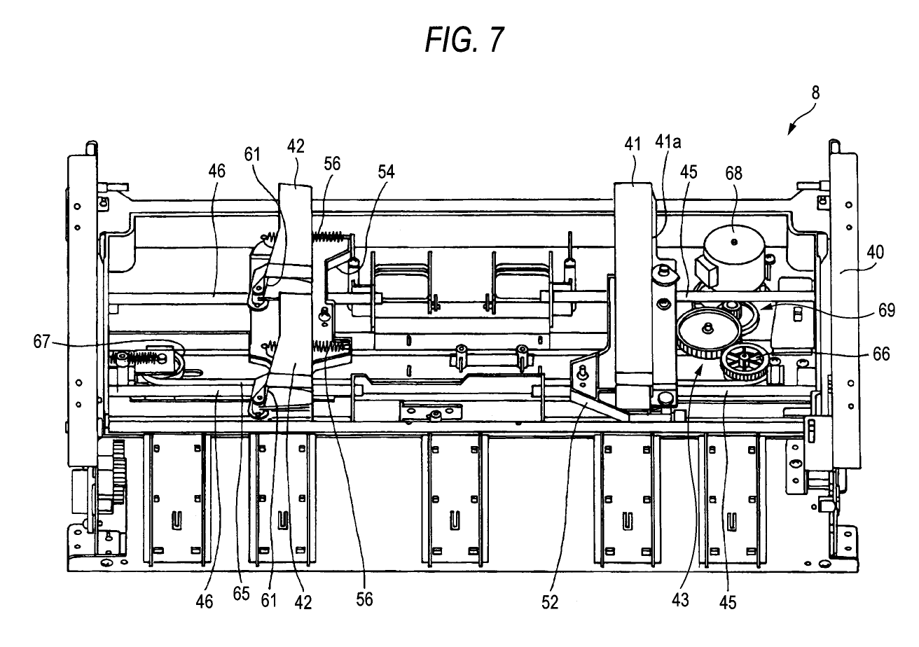

As shown in FIGS. 5 and 6, the position correcting section 8 is placed on a base plate 40 built within the apparatus body 2 and faces against the reference plate 41 that supports one side edge of the printing sheet 3 and lever guide plates 42 that face against the reference plate 41 and press the other side edge of the printing sheet 3. A moving mechanism 43 shown in FIG. 7 can move the reference plate 41 and lever guide plates 42 toward or away from each other over the base plate 40b and in the direction orthogonal to the direction of transfer of the printing sheet 3.

The position correcting section 8 is exposed to the outside by opening a top 44 on the upper surface of the apparatus body 2. Thus, the printer apparatus 1 can be maintained by opening the top 44 when the printing sheet or sheets 3 jams or the like in the position correcting section 8. The top 44 is omitted from the apparatus body 2 in FIG. 5 in order to show the external view of the position correcting section 8.

As shown in FIG. 7, the base plate 40 has a substantially rectangular form as a whole, and the longitudinal direction is placed orthogonally to the direction of transfer of the printing sheet 3. The base plate 40 has a pair of guide axes 45 and 45 from one end in the longitudinal direction to a substantially middle part, and the reference plate 41 is supported through the guide axes 45 and 45. The base plate 40 further has a pair of guide axes 46 and 46 from the other end in the longitudinal direction to the substantially middle part, and the lever guide plates 42 are supported through the guide axes 46 and 46. Thus, the reference plate 41 and lever guide plates 42 can be moved along the guide axes 45 and 46 and can be moved toward or away from each other in the direction orthogonal to the direction of transfer of the printing sheet 3.

As shown in FIG. 7, the base plate 40 has an endless belt 65 included in the moving mechanism 43, which will be described later, and a pair of pulleys 66 and 67 around which the endless belt 65 is winded between the guide axes 45 and 45 and between the guide axes 46 and 46. Notably, the guide axes 45 and 46 and the moving mechanism 43 are covered by a protective cover 47 above the base plate 40, as shown in FIG. 6, and is prevented from making contact with the printing sheet 3.

The base plate 40 further has a middle pickup roller 48 at a substantial middle part in the longitudinal direction for transferring the printing sheet 3 to the printing section 7. The middle pickup roller 47 feeds the printing sheet 3 particularly in a smaller size toward the capstan roller 33a and pinch roller 34a side and can be hoisted/lowered by a hoisting and lowering mechanism, the details of which will be omitted herein, over the protective cover 47 through the opening 49 of the protective cover 47. The middle pickup roller 48 faces against a roller follower, not shown, on the top 44 that blocks above the position correcting section 8. The middle pickup roller 48 hoisted above the protective cover 47 holds and feeds the printing sheet 3 together with the roller follower.

The middle pickup roller 48 hoisted above the protective cover 47 thus transfers the printing sheet 3, which has been transferred from the transfer section 6, to the position correcting section 8. Then, the middle pickup roller 48 is laid by below the protective cover 47 so that the position correcting section 8 can correct the position of the printing sheet 3. After the position of the printing sheet 3 is corrected, the middle pickup roller 48 is hoisted above the protective cover 47 again, and the positionally corrected printing sheet 3 is fed toward the capstan roller 33a and pinch roller 34a side.

The base plate 40 further has a transfer detection lever 50 near the opening 49 and on the upstream side in the direction of transfer of the printing sheet 3 for detecting that the printing sheet 3 has been transferred to a predetermined position of the position correcting section 8. The transfer detection lever 50 is rotatably supported in the direction of transfer of the printing sheet 3. The end is typically caused to face the protective cover 47 from above by an urging member and can be abutted to the printing sheet 3. The transfer detection lever 50 is pressed and is inclined by the upper edge of the transferred printing sheet 3 when the printing sheet 3 is transferred. Thus, the transfer detection lever 50 can detect that the printing sheet 3 has been transferred to a predetermined position of the position correcting section 8. The printer apparatus 1 stops the middle pickup roller 48 after a lapse of a predetermined period of time from the inclination of the transfer detection lever 50 in accordance with the size of the printing sheet 3, which is detected in advance, and transfers the printing sheet 3 to a predetermined position of the position correcting section 8.

For clarification of the constructions of the reference plate 41 and lever guide plates 42, the middle pickup roller 48 and transfer detection lever 50 are omitted in FIG. 7. The printer apparatus 1 further includes a second transfer detection lever, not shown, between the position correcting section 8 and the printing section 7 for detecting the transfer position of the printing sheet 3 in a large size. Like the transfer detection lever 50, the second transfer detection lever is also supported so as to be able to incline in the direction of the transfer of the printing sheet 3 and detects that the printing sheet 3 has been transferred to a predetermined position of the position correcting section 8 by being pressed by the upper edge of the transferred printing sheet 3.

The transfer detection lever 50 and the second transfer detection lever are used differently according to the size of the transferred printing sheet 3. In other words, the center of the printing sheet 3 in all sizes in the direction of transfer is necessarily positioned between the supporting sections 60 and 60 of the two lever guide plates 42, and the amount of transfer of the printing sheets 3 in the position correcting section 8 depends on the size. Therefore, the printer apparatus 1 transfers the printing sheet 3 in a small size for a predetermined period of time from the inclination of the transfer detection lever 50 and transfers the printing sheet 3 in a large size for a predetermined period of time until the second transfer detection lever is inclined or from the inclination.

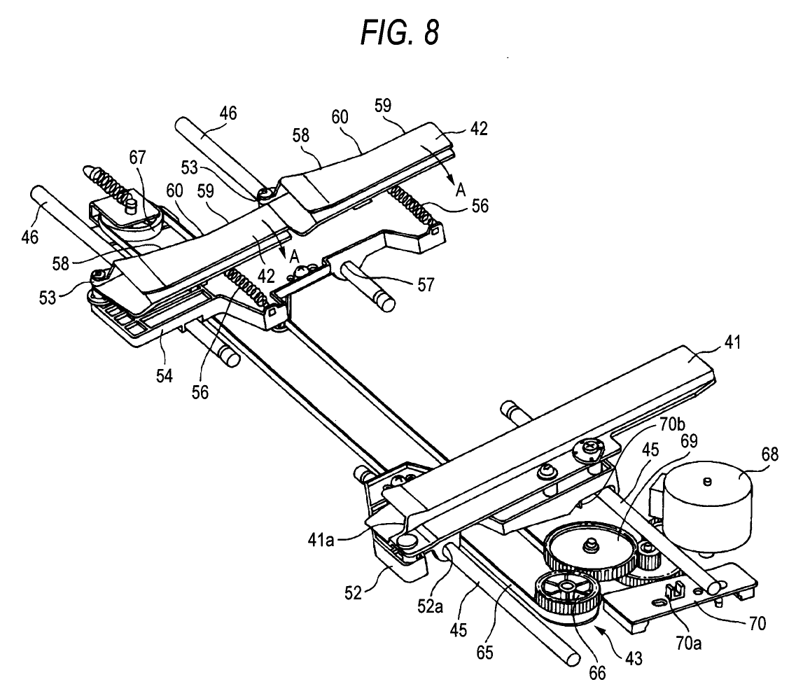

The reference plate 41 supported by the base plate 40 is molded of a synthetic resin in a rectangular form as shown in FIG. 8. The reference plate 41 is fastened with a screw on a reference plate base 52, and the longitudinal side is thus supported toward the direction of transfer of the printing sheet 3. In other words, the reference plate 41 supports one side edge of the printing sheet straight in the longitudinal direction, and the printing sheet 3 can thus be corrected to the proper direction in which the upper edge of the printing sheet 3 and the thermal head 30 face right to each other. The reference plate 41 supported on the reference plate base 52 is thus placed over the protective cover 47 through a long hole 51 of the protective cover 47.

The reference plate base 52 has a through hole 52a through which the pair of guide axes 45 and 45 supported at one end side of the base plate 40 is provided and is movable along the guide axes 45 and 45. The reference plate base 52 is connected with one part of the endless belt 65 that holds the pair of pulleys 66 and 67 and is moved in accordance with the rotation of the endless belt 65.

The reference plate 41 has a section in a substantially inverted-C form in the longitudinal direction and thus has a guide channel form having a supporting wall 41a that supports one side edge of the printing sheet 3 in the longitudinal direction. Therefore, the reference plate 41 supports the one side edge in the longitudinal direction with the supporting wall 41a when abutted to the one side edge of the printing sheet 3.

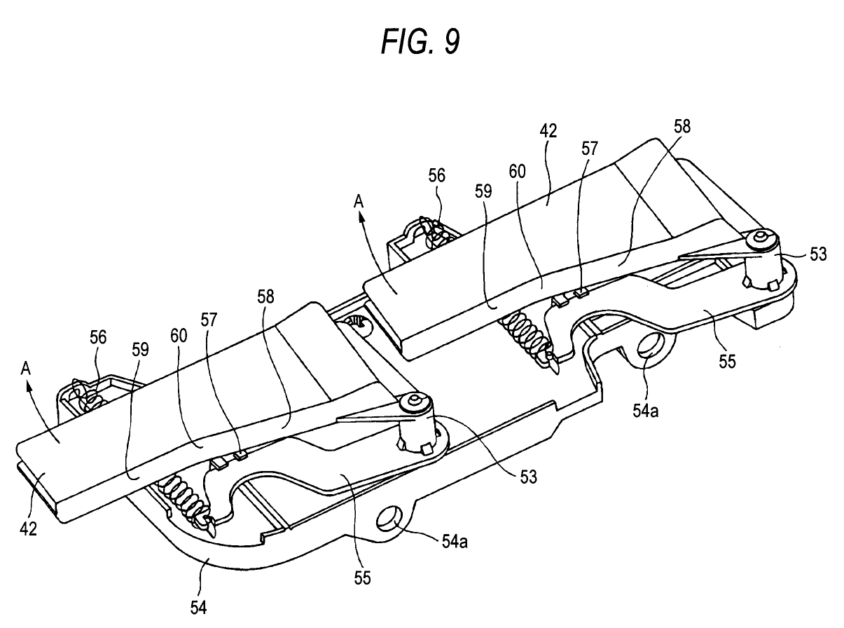

As shown in FIGS. 8 and 9, each of the lever guide plates 42 is molded on a synthetic resin in a rectangular form. The lever guide plate 42 has a bearing section 53 at one end in the longitudinal direction. A shaft standing from the lever guide plate base 54 through the bearing section 53 allows the lever guide plate 42 to be pivotably supported on the lever guide plate base 54. The lever guide plate 42 supported on the lever guide plate base 54 is thus placed above the protective cover 47 through a long hole 62 of the protective cover 47.

The bearing section 53 is connected with a relay lever 55. The relay lever 55 is latched with one end of an urging spring 56 having the other end latched with the lever guide plate base 54. Thus, the lever guide plate 42 receives the urging force of the urging spring 56 through the relay lever 55 and is thus urged to rotate in the arrow A direction in FIGS. 8 and 9 on the reference plate 41 side. Notably, the rotation position in the arrow A direction of the lever guide plate 42 is determined by the relay lever 55 latched with a stopper piece 57 on the lever guide plate base 54, and the lever guide plate 42 can be rotated from the determined position in the opposite direction of the arrow A direction.

The lever guide plate 42 has a section in a substantially inverted-C form in the longitudinal direction, which is a guide channel form that supports the other side edge of the printing sheet 3. The lever guide plate 42 has a first tilting guide section 58 that tilts toward the reference plate 41 side in the direction of transfer of the printing sheet 3 and a second tilting guide section 59 that tilts toward the opposite side of the reference plate 41 in the direction of transfer of the printing sheet 3. The first tilting guide section 58 and the second tilting guide section 59 are continuous in the longitudinal direction. Thus, the contact parts with guide sections 58 and 59 are bent, and the contact parts inflate toward the reference plate 41 side. Therefore, the contact parts may be handled as a supporting section 60 supporting the other side edge of the printing sheet 3 by point contact. As a result, when the lever guide plate 42 is abutted to the other side edge of the printing sheet 3, the supporting section 60 is brought into point contact with the other side edge.

Notably, the second tilting guide section 59 on the more downstream side in the direction of transfer than the first tilting guide section 58 is in contact with the first tilting guide section 58 in the direction and angle, which do not allow the rotation toward the reference plate 41 from the supporting section 60 when the urging spring 56 rotates the lever guide plate 42 in the arrow A direction and the relay lever 55 is latched with the stopper piece 57, that is, even when the lever guide plate 42 is rotated in the arrow A direction most. Since the lever guide plate 42 is not rotated in the arrow A direction more from the determined position where the relay lever 55 is latched with the stopper piece 57, the other side edge of the printing sheet 3 and the supporting section 60 are not typically brought into point contact with each other.

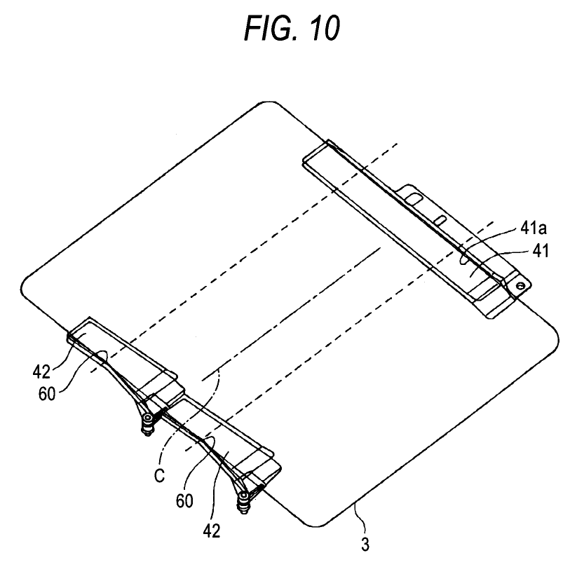

As shown in FIGS. 8 and 9, two lever guide plates 42 adjacent to each other are supported in the direction of transfer of the printing sheet 3 on the lever guide plate base 54. Therefore, the other side edge of the printing sheet 3 is brought into contact by two points with the supporting sections 60 of the two lever guide plates 42. More specifically, the two lever guide plates 42 and 42 are abutted to both sides across the center line C in the direction of transfer of the printing sheet 3 by the supporting sections 60 and 60, as shown in FIG. 10. Thus, by urging the front and back of the other side edge toward the reference plate 41 side by the supporting sections 60, the lever guide plates 42 can correct the printing sheet 3 transferred in any direction, such as with the front side in the direction of transfer deviated toward the lever guide plates 42 side or the rear side in the direction of transfer deviated toward the lever guide plates 42 side. Notably, since the fact that the printing sheet 3 has been transferred to a predetermined position based on the inclination of the transfer detection lever 50, the center line C of the printing sheet 3 in the direction of transfer can be positioned between the supporting sections 60 and 60 by transferring the printing sheet 3 for a predetermined period of time after that.

The lever guide plate 42 has a loading section 61 at the insertion end, which is the tilt of the first tilting guide section 58 having a wider part on the opposite side of the reference plate 41 toward the opposite side of the direction of transfer of the printing sheet 3. The loading section 61 pulls the printing sheet 3 in between the reference plate 41 and the lever guide plates 42. The reference plate 41 and the lever guide plates 42 are spaced apart by the width allowing reception of both side edges of the printing sheet 3 by the guide channel form in the standby state for transfer of the printing sheet 3, as described later. If a displacement of the printing sheet 3 exceeds the standby width, the loading section 61 of the lever guide plate 42 absorbs the displacement of the printing sheet 3. When another side edge of the printing sheet 3 is abutted to the loading section 61, the lever guide plates 42 press the printing sheet 3 toward the reference plate 41 side with the urging force of the urging spring 56 by rotating in the opposite direction of the arrow A direction. Thus, the lever guide plates 42 can transfer the printing sheet 3 to between the lever guide plates 42 and the reference plate 41. Notably, the reference plate 41 is not configured to rotate toward the lever guide plates 42 side and may not rotate and press the printing sheet 3 in the opposite direction of the direction of rotation, unlike the lever guide plates 42. Therefore, the reference plate 41 has no loading section.

The lever guide plate base 54 has a through-hole 54a through which the pair of guide axes 46 and 46 is supported by the other end side of the base plate 40 and is movable along the guide axes 46 and 46. The lever guide plate base 54 is connected with the other of the endless belt 65 holding the pair of pulleys 66 and 67 and is movable with the rotation of the endless belt 65.

Next, the moving mechanism 43 will be described which moves the reference plate base 52 and the lever guide plate base 54. The moving mechanism 43 moves the reference plate base 52 and the lever guide plate base 54 along the guide axes 45 and 45 or guide axes 46 and 46 to move the reference plate 41 and lever guide plates 42 toward or away from each other.

The moving mechanism 43 includes the endless belt 65, the pair of pulleys 66 and 67, a driving motor 68 and a gear array 69. The endless belt 65 is connected with the reference plate base 52 and the lever guide plate base 54. The endless belt 65 is wound about the pair of pulleys 66 and 67. The driving motor 68 rotates a driving pulley 66. The gear array 69 transmits the driving force of the driving motor 68 to the driving pulley 66.

The wireless belt 65 is wound about between the driving pulley 66 and the pulley follower 67 placed on both sides in the longitudinal direction of the base plate 40. The reference plate base 52 is connected to one side of the endless belt 65 holding the pulleys 66 and 67, and the lever guide plate base 54 is connected to the other side. Thus, by rotating the pair of pulleys 66 and 67, the wireless belt 65 can move the reference plate base 52 and the lever guide plate base 54 in the opposite direction of and in synchronization with each other.

The driving motor 68 is a stepping motor that step-feeds the reference plate base 52 and lever guide plate base 54 toward or away from each other through the gear array 69, the pair of pulleys 66 and 67 and wireless belt 65.

A detection switch 70 is provided near the driving pulley 66 on the area where the reference plate base 52 is movable. The detection switch 70 detects the positions of the reference plate base 52 and lever guide plate base 54. The detection switch 70 detects the initial positions of the reference plate base 52 and the lever guide plate base 54 that moves in synchronization with the reference plate base 52 by detecting that the reference plate base 52 has been transferred to the immediate thereabove. The moving mechanism 43 is step-fed by a predetermined amount from the initial position in accordance with the size of the printing sheet 3 to be transferred.

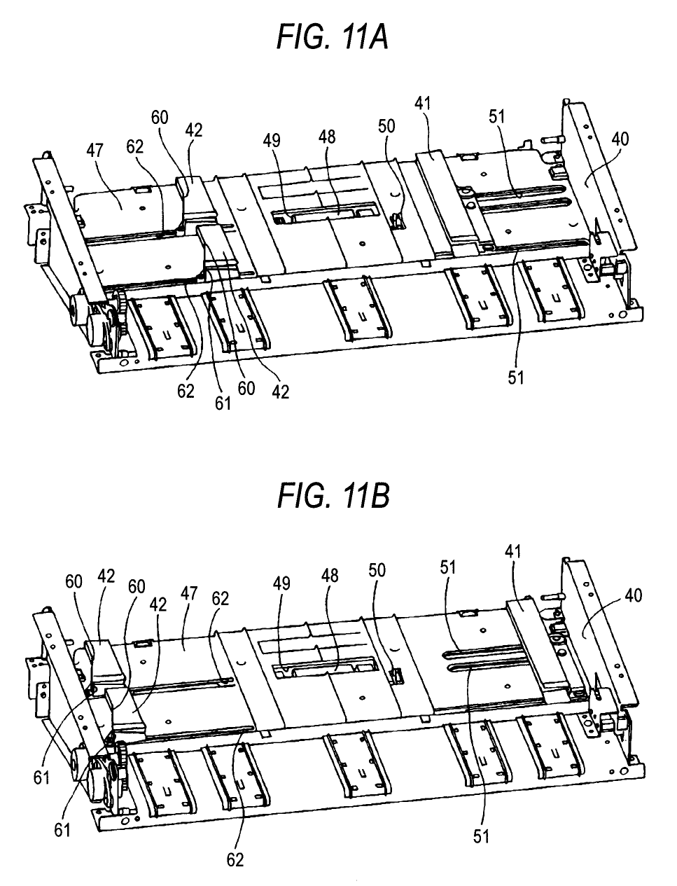

In other words, since the printing sheets 3 in four sizes are prepared for different applications, the width between the reference plate 41 and the lever guide plates 42 is changed according to the size. For example, if the printing sheet 3 has a size as small as 8×10 (inches), the reference plate 41 and the lever guide plates 42 are moved toward each other as shown in FIG. 11A. If the printing sheet 3 has a size as large as 14×17 (inches), the reference plate 41 and the lever guide plates 42 are moved away from each other as shown in FIG. 11B. The moving mechanism 43 adjusts the width between the reference plate base 52 and the lever guide plate base 54 according to the size of the printing sheet 3 for each printing operation.

Notably, as shown in FIG. 8, the detection switch 70 may include a photosensor 70a and a rib 70b. The photosensor 70a may be provided on the base plate 40. The rib 70b projects downward from the bottom surface of the reference plate base 52 and passes through the photosensor 70a. Alternatively, the detection switch 70 may further include a lever switch on the base plate 40 and a rib that projects downward from the bottom surface of the reference plate base 52 and presses down the lever switch. The detection switch 70 may be provided on the other side of the base plate 40 and may detect the initial position of the lever guide plate base 54.

The moving mechanism 43 has a configuration in which the endless belt 65 connecting with the reference plate base 52 and lever guide plate base 54 is wound about the pair of pulleys 66 and 67 to drive one driving motor 68, which can reduce the number of parts and the space. The moving mechanism 43 may have a driving motor and a transmitting mechanism that transmits the driving force of the driving motor in each of the reference plate base 52 and lever guide plate base 54, which may thus be moved separately.

When the printing sheet 3 is transferred to a predetermined correction position according to the size of the printing sheet 3 by the transfer roller 27 and middle pickup roller 48 of the transfer section 6, the moving mechanism 43 moves the reference plate 41 and lever guide plates 42, which stand by with a slightly wider space than the width of the printing sheet 3 therebetween, toward each other until the width between the supporting wall 41a and the supporting sections 60 is equal to a predetermined space, which is equal to or smaller than the width of the printing sheet 3, in the position correcting section 8.

Thus, one side edge of the printing sheet 3 is abutted, in the longitudinal direction, to the supporting wall 41a of the reference plate 41. The supporting sections 60 of the lever guide plates 42 are bought into point-contact with the other side edge of the printing sheet 3. Here, the reference plate 41 and the lever guide plates 42 are spaced apart by a predetermined width equal to or smaller than the width of the printing sheet 3, and the position of the reference plate 41 is fixed. Therefore, each of the lever guide plates 42 is rotated in the opposite direction of the arrow A direction by the counterforce of the printing sheet 3, and the supporting section 60 presses the other side edge of the printing sheet 3 with the urging force of the urging spring 56.

The printing sheet 3 is transferred such that the longitudinal center line C can be positioned between the supporting sections 60 and 60 of the two lever guide plates 42 and 42 based on the detected transfer position by the transfer detection lever 50.

In this way, one side edge of the printing sheet 3 is supported straight by the reference plate 41, and both sides across the longitudinal center of the other side edge is pressed by point contact by the supporting sections 60 of the two lever guide plates 42. Thus, the printing sheet 3 with the upper side edge being not parallel with the longitudinal direction of the thermal head 30 can be corrected to the proper attitude for facing right to the longitudinal direction of the thermal head 30 in parallel.

Since the position correcting section 8 includes the moving mechanism 43 and can adjust the distance between the reference plate 41 and the lever guide plates 42 in the positional correction operation on the printing sheet 3. Thus, the positions of the printing sheets 3 in multiple sizes can be corrected. The position correcting section 8 may further adjust the correction position with reference to the position of the reference plate 41 and/or the pressing force by the supporting sections 60 of the lever guide plates 42 in accordance with various factors such as the size of the printing sheet 3 and the attitude of the apparatus body 2 in a positional correction operation on each of the printing sheets 3 and can perform optimum position correction on the transferred printing sheet 3.

The distance between the reference plate 41 and the lever guide plates 42 can be adjusted by changing the set value in the correction control section 85 that drives the moving mechanism 43, as described later. For example, the position correcting section 8 adjusts the distance between the reference plate 41 and the lever guide plates 42 so as to be equal to or smaller than the width of the printing sheet 3 based on the size of the printing sheet 3 to be transferred. When the apparatus body 2 is vertically placed, by which the sheet surface of the printing sheet 3 faces horizontally, the position correcting section 8 adjusts the distance between the reference plate 41 and the lever guide plate 42 in order to prevent the printing sheet 3 and/or the reference plate 41 or lever guide plates 42 from falling down in the direction of gravity. Thus, the pressing force by the lever guide plate 42 can be adjusted.

After the position correction on the printing sheet 3 ends, the middle pickup roller 48 rises and holds the printing sheet 3 together with the roller follower on the top 44, or the capstan roller 33a and pinch roller 34 hold the printing sheet 3. Next, the moving mechanism 43 moves the reference plate 41 and lever guide plates 42 toward or away from each other, and the printing sheet 3 is then released. Thus, the position correcting section 8 can transfer the printing sheet 3, which has been corrected to a proper attitude, to the printing section 7.

Notably, the reference plate 41 and the lever guide plates 42 form a guide channel shape with a section in an inverted-C form that supports both side edges of the printing sheet 3 vertically and horizontally. Thus, the transfer of the printing sheet 3 can be guided, and vertical and horizontal warps can be prevented. Since, in the printer apparatus 1, the reference plate 41 and the lever guide plates 42 can be moved toward or away from each other, it is difficult to provide a guide rib, for example, on the top 44 or the base plate 40 for guiding the transfer of the printing sheet 3 in order to prevent a collision or friction between the reference plate 41 and the lever guide plates 42 in the movement area. Therefore, in the printer apparatus 1, the reference plate 41 and the lever guide plate 42 form a guide channel shape, which guides the transfer of the printing sheet 3.

The ejecting section 9 includes an ejection roller 75 for ejecting the printing sheet 3 and a feeding roller 76 press-fitted to the ejection roller 75, and the printing sheet 3 on which an image is printed is ejected from the front of the apparatus body 2.

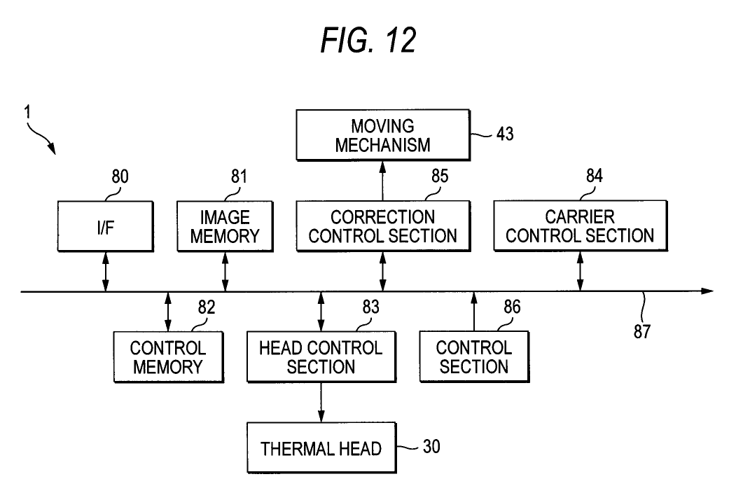

Describing the circuit configuration of the printer apparatus 1 having the construction as described above, the printer apparatus 1 includes an interface (which will be simply called I/F) 80. an image memory 81, a control memory 82, a head control section 83, a transfer control section 84, a correction control section 85 and a control section 86, which are connected via a bus 87, as shown in FIG. 12. Image data to be printed is input to the I/F 80. The image memory 81 stores image data input from the I/F 80. The control memory 82 stores a control program and so on. The head control section 83 controls an operation by the thermal head 30. The transfer control section 84 drives a motor functioning as a driving source for the transfer roller 27 and capstan roller 33, for example, which pass the printing sheet 3 from the tray 4 to the ejecting section 9. The correction control section 85 drives the moving mechanism 43 of the position correcting section 8 according to the size, for example, of the printing sheet 3. The control section 86 controls the correction control section 85 and the head control section 83 through the bus 87.

The I/F 80 is connected to a display device such as an LCD (liquid crystal display) and a CRT (cathode ray tube) displaying an image to be printed and a host machine 101 (FIG. 3) such as a personal computer in which image data supplied from an imaging apparatus such as an MRI is recorded. The I/F 80 receives input of image data recorded in an electric machine and/or image data recorded on a recording medium such as an optical disk and an IC card. An electric machine is connected to the I/F 80 in a wired manner or wireless based on standards such as USB (Universal Serial Bus), IEEE (the Institute of Electrical and Electronic Engineers) 1394 and a Bluetooth.

The image memory 81 has a capacity that can store at least one piece of image data, and image data to be printed, which is input from the I/F 80, is input thereto and is temporarily stored therein. The control memory 82 stores a control program that controls entire operations by the printer apparatus 1. The head controls action 83 controls an operation by the thermal head 30 based on a control program stored in the control memory 82. For example, the head control section 83 controls the driving current of the thermal head 30 to drive the thermal head 30 according to the image to be printed. The transfer control section 84 controls the transfer speed of the printing sheet 3 by the pickup roller 21 and/or pickup motor 25 of the takeout mechanism 20 or the transfer roller 27 of the transfer section 6 based on a control program stored in the control memory 82. The correction control section 85 controls the driving motor 68 of the moving mechanism 43 according to the size and/or the number of the printing sheets 3 to be printed based on a control program stored in the control memory 82 to perform an operation of moving the reference plate 41 and the lever guide plates 42 toward or away from each other. The control section 86 controls the correction control section 85 and the head control section 83 based on information stored in the image memory 81 or control memory 82, information on the size, for example, of the printing sheet 3 read from an IC tag of a package attached to the tray 4 and/or information detected by the transfer detection lever 50 that detects the transfer position of the printing sheet 3 or the detection switch 70 of the moving mechanism 43.

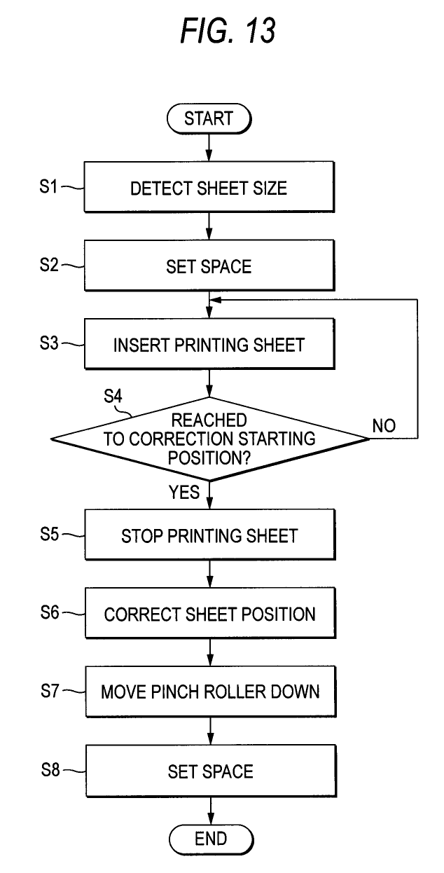

Next, printing steps of the printer apparatus 1 having the configuration as described above will be described. As shown in FIG. 13, the control section 86 detects the size of the printing sheet 3 by the reading section on the tray 4 in step S1 in response to the instruction to perform a printing operation from the host machine 101. In step S2, the control section 86 controls the correction control section 85 to drive the moving mechanism 43 based on the detected size information of the printing sheet 3 such that the standby width between the reference plate 41 and the lever guide plates 42 can be wider than the width of the printing sheet 3 to be transferred.

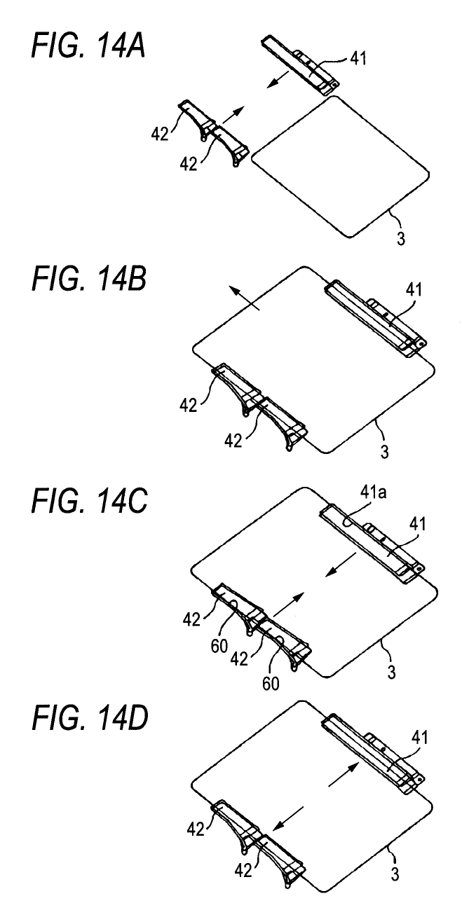

Here, the moving mechanism 43 first moves the reference plate 41 and lever guide plates 42 away from each other, as shown in FIG. 11B, and transfers the printing sheet 3 to the initial position by detecting the rib on the reference plate base 52 by the detection switch 70 on the base plate 40. After that, as shown in FIG. 14A, the moving mechanism 43 moves the reference plate 41 and the lever guide plate 42 toward each other, and the printing sheet 3 is fed to a predetermined standby position where both side edges of the printing sheet 3 can be supported.

In step S3, the transfer control section 84 drives the pickup roller 21 of the takeout mechanism 20 and the transfer roller 27 of the transfer section 6 to transfer the printing sheet 3 from the tray 4 into the inside of the position correcting section 8. In step S4, whether the printing sheet 3 has been transferred to a predetermined transfer position or not, that is, whether the center in the direction of transfer has been transferred to between the supporting sections 60 and 60 of the two lever guide plates 42 or not is detected. The transfer position of the printing sheet 3 is detected by the inclination of the transfer detection lever 50 or second transfer detection lever toward the upper edge of the printing sheet 3 and the measurement of a predetermined period of time for the transfer then. The control section 86 determines either transfer detection lever 50 or second transfer detection lever to be used as a reference for the detection of the transfer position according to the detected size of the printing sheet 3 and drives the transfer control section 84.

Then, the control section 86 keeps driving the transfer section 6 if the printing sheet 3 has not been transferred to a predetermined position. In step S5, the transfer section 6 is stopped if the printing sheet 3 is transferred to the predetermined position, as shown in FIG. 14B.

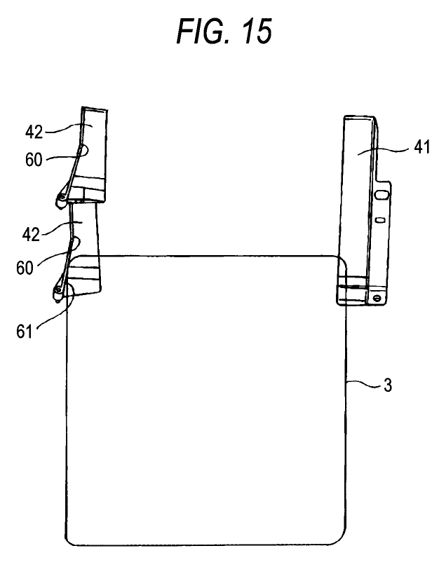

Notably, since each of the lever guide plates 42 has the loading section 61 expanding on the opposite side of the reference plate 41 in the opposite direction of the direction of transfer of the printing sheet 3, the printing sheet 3 can be pulled by the loading section 61 in between the reference plate 41 and the lever guide plates 42 even in a case where the transferred printing sheet 3 is displaced in the width direction from the area between the reference plate 41 and the lever guide plates 42, which have been transferred to the standby position, as shown in FIG. 15.

Notably, before the printing sheet 3 is transferred to the position correcting section 8, the middle pickup roller 48 is lowered from the above of the base plate 40, and the pinch roller 34a is hoisted away from the capstan roller 33a. Thus, the middle pickup roller 48 and the pinch roller 34a are retracted from the transfer area for the printing sheet 3.

In step S6, as shown in FIG. 14C, the correction control section 85 controls to move the reference plate 41 and the lever guide plates 42 toward each other, and the positional correction is performed on the printing sheet 3. Here, the moving mechanism 43 is controlled such that the space between the supporting wall 41a of the reference plate 41 and the supporting sections 60 of the lever guide plates 42 can be equal to or shorter than the width of the printing sheet 3. Thus, one side edge of the printing sheet 3 is supported in the longitudinal direction by the supporting wall 41a of the reference plate 41, and the other side edge is pressed against the supporting sections 60 of the lever guide plates 42 to which urging force is applied in the arrow A direction by being rotated in the opposite direction of the arrow A direction. Therefore, one side edge of the printing sheet 3 is pressed against the supporting sections 60 with which the other side edge is in point contact, and the one side edge is supported by the supporting wall 41a straight. As a result, even when the upper side edge is transferred by the transfer section 6 not in parallel with the longitudinal direction of the thermal head 30, the printing sheet 3 is corrected to the proper attitude where the upper side edge and the longitudinal direction of the thermal head 30 can be parallel.

Since the center of the printing sheet 3 in the direction of transfer is positioned between the supporting sections 60 and 60 of the two lever guide plates 42 as shown in FIG. 10, the printing sheet 3 with any horizontal displacement about the direction of transfer can be corrected to the proper attitude.

Notably, the distance between the reference plate 41 and the lever guide plates 42 is predefined to a predetermined value by the correction control section 85. The distance is defined according to the size of the printing sheet 3 and further according to factors such as the positional relationship between the printing sheet 3 and the thermal head 30, optimum pressing force for the positional correction on the printing sheet 3 by the lever guide plates 42, and the attitude where the apparatus body 2 is placed or a combination of these factors.

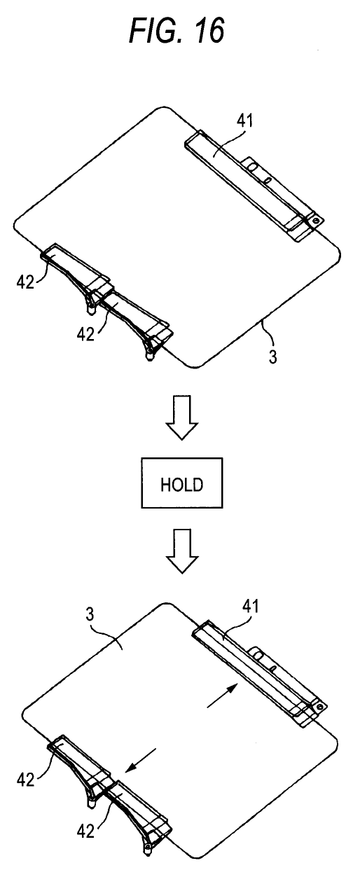

After the positional correction on the printing sheet 3, the middle pickup roller 48 is hoisted and holds the printing sheet 3 together with the roller follower, or the pinch roller 34a is lowered and holds the printing sheet 3 together with the capstan roller 33a, in step S7, as shown in FIG. 16.

Next, in step S8, as shown in FIG. 14D, the reference plate 41 and the lever guide plates 42 are moved away from each other to the standby position, and the printing sheet 3 is released and is ready for transfer to the printing section 7. Since the printing sheet 3 is held by the middle pickup roller 48 and the roller follower or by the capstan roller 33a and the pinch roller 34a, the printing sheet 3 is not displaced when released. The release of the reference plate 41 and the lever guide plates 42 from the printing sheet 3 to be transferred to the printing section 7 is for preventing the displacement and/or the possibility of adversely affecting on the printing quality. The side edge of the printing sheet 3, which is supported by the reference plate 41 and the lever guide plate 42, to be transferred to the printing section 7 may expose to the impact caused when the urging by the lever guide plates 42 is cancelled at the time when the side edge of the printing sheet 3 passes by the upstream edges in the direction of transfer of the reference plate 41 and the lever guide plates 42 .

The printer apparatus 1 performs the positional correction operation for the printing sheet 3 on each of the printing sheets 3. The printing sheet 3 transferred to the printing section 7 is printed by the thermal head 30 and is then transferred to a density measuring section 78 by a return roller 77 (FIG. 4). The density measuring section 78 includes a density measuring device, not shown, for measuring the print density on the transferred printing sheet 3. If the measurement results in the occurrence of a problem such as an uneven print density, the fact that there is the problem may be displayed on a monitor provided on the host machine 101 side, for example. Finally, the printing sheet 3 is ejected to an ejection tray 79 of the ejecting section 9 through the density measuring section 78.

Notably, the printer apparatus 1 may perform the positional correction operation multiple times on one printing sheet 3. For example, by performing the positional correction operation twice, the printing sheet 3 having a large displacement can be corrected to a proper attitude by the second correction operation even if the positional correction by the first correction operation is not enough.

Here, the control section 86 moves the reference plate 41 and the lever guide plates 42 toward and then away from each other until the distance between the supporting wall 41a and the supporting sections 60 can be equal to or shorter than the width of the printing sheet 3 and then moves the reference plate 41 and the lever guide plates 42 toward each other again to perform the positional correction. After that, the printing sheet 3 is held by the middle pickup roller 48 and the roller follower or the capstan roller 33a and the pinch roller 34a and is released from the reference plate 41 and the lever guide plates 42.

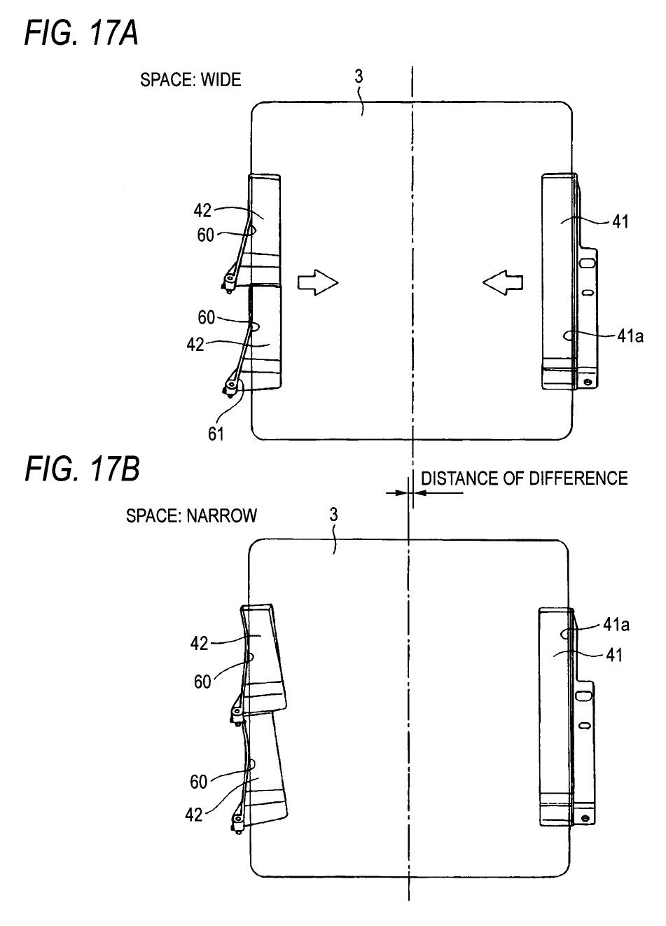

The printer apparatus 1 may have different approaching distances between the reference plate 41 and the lever guide plates 42 among positional operations, as shown in FIGS. 17A and 17B, in the range that the distance between the supporting wall 41a and the supporting sections 60 can be equal to or shorter than the width of the printing sheet 3. For example, in a case where the approaching distance between the reference plate 41 and the lever guide plates 42 is different between the first and second positional correction operations, the control section 86 controls the correction control section 85 to move the position of the reference plate 41 to the left or right from the position under the first correction operation. Since the lever guide plates 42 are rotatably supported on the lever guide plate base 54, the lever guide plates 42 are rotated in the opposite direction of the arrow A direction larger than that of the first time if the reference plate 41 is closer than that of the first correction operation. If the reference plate 41 is farther than that of the first correction operation, the lever guide plates 42 are rotated in the opposite direction of the arrow A direction smaller than the first time, and the supporting sections 60 by using the urging force of the urging spring 56 press the other side edge of the printing sheet 3.

The differentiation of the distance between the reference plate 41 and the lever guide plates 42 between the first and second times can differentiate the pressing force to the printing sheet 3 by the urging force of the urging spring 56. Thus, the displacement of the printing sheet 3 can be corrected, which may not be absorbed enough by the urging force in the first correction operation. Since the positions of the supporting wall 41a of the reference plate 41 is only moved to the left and right even in a case where the distance between the reference plate 41 and the lever guide plates 42 is differentiated, the parallel relationship between the upper side edge of the printing sheet 3 and the longitudinal direction of the thermal head 30 is kept, which allows correction to a proper attitude. In this case, the energization area of the thermal head 30 is defined according to the corrected position of the printing sheet 3 in the last correction operation.

Here, the reference plate 41 and the lever guide plates 42 are moved to the left and right by about ±1.5 mm in the first correction operation and the second correction operation. The stroke can be selected as required, and the reference plate 41 and the lever guide plates 42 can be moved by different strokes between the correction operations. The reference plate 41 and the lever guide plates 42 can be adjusted roughly in the first correction operation and precisely in the second correction operation by increasing the urging force from the supporting sections 60 by decreasing the approaching distance in the second correction operation from the approaching distance in the first correction operation.

Furthermore, the printer apparatus 1 may perform the positional correction operation different times according to the size of the printing sheet 3. For example, the correction operation may be performed twice on the printing sheet 3 to be printed in a size as small as 10×12 or 8×10 (in inches). On the other hand, the correction operation may be performed only once on the printing sheet 3 to be printed in a size as large as 14×17 or 11×14 (in inches) since the possibility of the occurrence of displacement is low. Conversely, the correction operation may be performed only once on the printing sheet 3 to be printed in a small size since the printing sheet 3 is lightweight enough for easy positional correction, and the correction operation may be performed twice on the printing sheet 3 in a large size. The reference plate 41 and the lever guide plates 42 may be moved toward each other by an equal or different distance every time if the positional correction operation is performed multiple times.

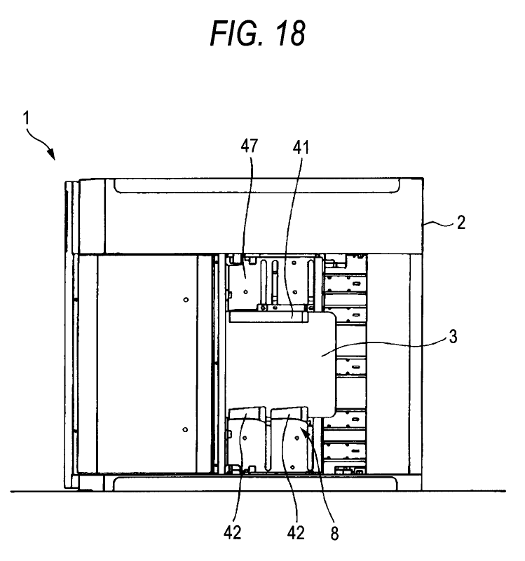

The printer apparatus 1 may perform the positional correction operation different times according to the attitude where the apparatus body 2 is placed. For example, in a case where the printer apparatus 1 is placed horizontally in which the printing sheet 3 is transferred from the tray 4 to the printing section 7 through the position correcting section 8 with the sheet surface facing vertically, the positional correction operation may be performed only once since the possibility of the occurrence of displacement is low. In a case where the printer apparatus 1 is placed vertically as shown in FIG. 18 in which the printing sheet 3 is transferred from the tray 4 to the printing section 7 through the position correcting section 8 with the sheet surface facing horizontally, the positional correction operation may be performed twice. In a case where the positional correction operation is performed multiple times, the approaching distances between the reference plate 41 and the lever guide plates 42 may be equal or different.

Next, printing steps will be described where images are printed serially on multiple printing sheets 3. In order to perform serial printing on multiple printing sheets 3 in an equal size, the control section 86 in the printer apparatus 1 controls the moving mechanism 43 to differentiate the approaching distance between the reference plate 41 and the lever guide plates 42 between/among the printing operation on one of the printing sheets 3 and the printing operation or operations on the other printing sheets 3.

In other words, the printing sheets 3 are available from multiple manufacturers, and some of them may have a burr at the outer edge. Therefore, when the printing sheets 3 are typically corrected to a same position before transferred to the printing section 7 in a case where serial printing is performed on the printing sheets 3 in an equal size, the burr occurring at the outer edge of the printing sheet 3 may damage the surface of the thermal head 30, which is abutted to the printing sheets 3, or a coat of dust may cause a strip appearing on a printed image, which may possibly decrease the printing quality.

Accordingly, the printer apparatus 1 avoids the situation that one part of the thermal head 80 is continuously exposed to friction by the outer edge of the printing sheet 3 by, in serial printing, changing the setting of the approaching distance between the reference plate 41 and the lever guide plates 42 for each predetermined number of sheets and moving the correction position of the printing sheets 3 horizontally. In other words, as shown in FIGS. 17A and 17B, the correction position of the printing sheet 3 by the position correcting section 8 is moved horizontally since the position of the reference plate 41, which is the reference, is moved horizontally by changing the distance between the reference plate 41 and the lever guide plates 42. Thus, the position correcting section 8 can move the transfer position of the printing sheet 3 about the thermal head 30, and the friction to one same part can be prevented. In moving the correction position of the printing sheet 3, the approaching distance between the reference plate 41 and the lever guide plates 42 and/or the spring constant of the urging spring 56 may be adjusted such that the urging force of the urging spring 56, which urges the lever guide plates 42 in the arrow A direction, can rotate the lever guide plates 42 within a predetermined range.

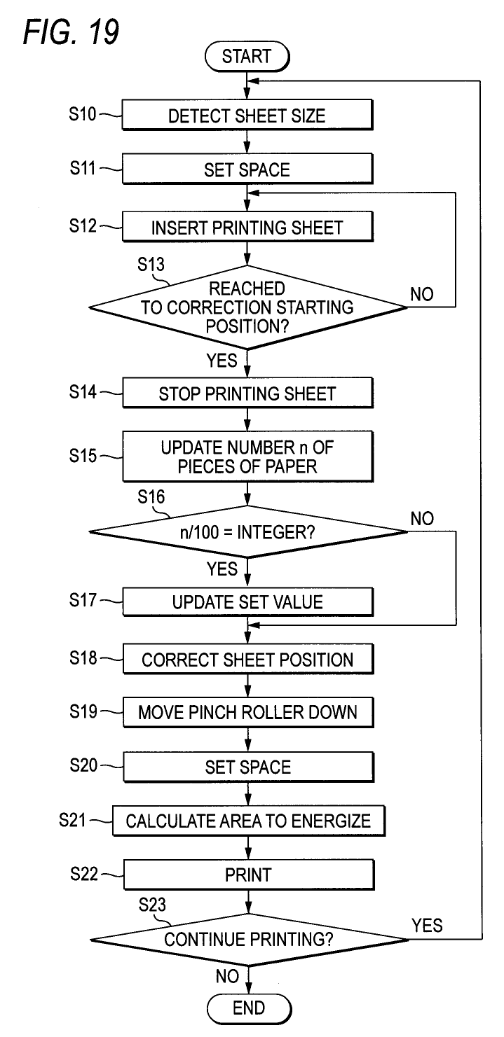

First in step S10, as shown in FIG. 19, the control section 86 in response to the instruction to perform a printing operation from the host machine 101 detects the size information of the printing sheet 3 by the reading section on the tray 4. In step S11, the control section 86 controls the correction control section 85 based on the detected size of the printing sheet 3 to drive the moving mechanism 43 such that the standby width between the reference plate 41 and the lever guide plate 42 can be wider than the width of the printing sheet 3 to be transferred.

Notably, also in this case, based on the results of the detection of the initial positions of the reference plate base 52 and the lever guide plate base 54 interlocking therewith by the detection switch 70, the moving mechanism 43 then step-pulse transfers the printing sheet 3 to the predetermined standby position according to the size of the printing sheet 3.

In step S12, the transfer control section 84 drives the pickup roller 21 of the takeout mechanism 20 and the transfer roller 27 of the transfer section 6 to transfer the printing sheet 3 from the tray 4 to the position correcting section 8. In step S13, like step S4 above, whether the printing sheet 3 has been transferred to the predetermined transfer position, that is, whether the center in the direction of transfer has been transferred to between the supporting sections 60 and 60 of the two lever guide plates 42 or not is detected. Then, if the printing sheet 3 has not been transferred to the predetermined position, the control section 86 keeps driving the transfer section 6. If the printing sheet 3 has been transferred to the predetermined position, the control section 86 stops the transfer section 6 in step S14.

Notably, before transferring the printing sheet 3 to the position correcting section 8, the middle pickup roller 48 is lowered from the base plate 40, and the pinch roller 34a is hoisted away from the capstan roller 33a. Thus, the middle pickup roller 48 and the pinch roller 34a are laid by from the transfer area of the printing sheet 3.

Next, in step S15, the control section 86 updates the number of printed sheets n from the start of the serial printing. In step S16, whether the number of sheets in the serial printing reaches a predetermined number or not is detected. In order to change the correction position of the printing sheet 3 for every 100 sheets, the value resulting from the division of the number of printed sheets n by the defined number 100 for change is an integer or not is detected. If so as a result, the control section 86 in step S17 changes the set value in the correction control section 85 so as to change the approaching distance between the reference plate 41 and the lever guide plates 42 in a positional correction operation and drives the moving mechanism 43 based on the newly defined value to move the reference plate 41 and the lever guide plate 42 toward each other to a predetermined correction position.

Thus, one side edge of the printing sheet 3 is supported in the longitudinal direction by the supporting wall 41a of the reference plate 41, and the other side edge is pressed against the supporting sections 60 of the lever guide plates 42. Thus, the printing sheet 3 is corrected to the proper attitude where the upper edge and the longitudinal direction of the thermal head 30 are parallel (step S18). The position correcting section 8 changes the correction position of the printing sheet 3 since the change of the set value in the correction control section 85 changes the position of the reference plate 41 from that of the previous correction operation. Therefore, the position correcting section 8 can change the friction position between the printing sheets 3 and the thermal head 30, which can prevent a damage and/or a coat of dust due to the repetitive friction against one same part.

On the other hand, if the value resulting from the division of the number of printed sheets n by the set number of sheets 100 for change is not an integer in step S16, the control section 86 does not change the set value in the correction control section 85 but drives the moving mechanism 43 based on the set value in the past to move the reference plate 41 and the lever guide plates 42 toward each other to a predetermined correction position, and the position correction is performed on the printing sheet 3 (step S18).

In step S19, after the position correction is performed on the printing sheet 3, the middle pickup roller 48 is hoisted and holds the printing sheet 3 together with the roller follower, as shown in FIG. 16, or the pinch roller 34a is lowered and holds the printing sheet 3 together with the capstan roller 33a. Next, in step S20, the reference plate 41 and the lever guide plates 42 are moved away from each other to the standby position, and the printing sheet 3 is released and is ready for the transfer to the printing section 7.

Next, in step S21, the energization area of the thermal head 30 is calculated according to the correction position of the printing sheet 3. This is because it is important to prevent printing out of registration on the printing sheet 3, for example, by correcting the energization area according to the positional correction of the transfer since the thermal head 30 has a line of multiple heat generating elements, and printing on the printing sheet 3 is performed by controlling the amount of current according to the tone level of the multiple heat generating elements and using the thermal energy generated at that time.

Next, in step S22, printing is performed on the printing sheet 3 by the thermal head 30 with the corrected energization area. The printed printing sheet 3 is transferred to the ejection tray 79 of the ejecting section 9 through the density measuring section 78. Next, in step S23, whether the serial printing is to be continued or not is determined. If so, the processing returns to step S10.

Notably, the printer apparatus 1 may perform the positional correction operation on each of the printing sheets 3 multiple times in the serial printing process. In a case where the positional correction operation is to be performed on each of the printing sheets 3 multiple times, the approaching distance between the reference plate 41 and the lever guide plates 42 may differ between the first operation and the second operation, as shown in FIGS. 17A and 17B. Furthermore, the approaching distance in the second correction operation may be shorter than the approaching distance in the first correction operation, which can increase the urging force from the supporting section 60. Thus, the approaching distance can be adjusted roughly in the first operation and precisely in the second operation.

The printer apparatus 1 also in the serial printing process may perform the positional correction operation on each of the printing sheets 3 different times according to the size of the printing sheet 3, as described above, or may perform the positional correction operation on each of the printing sheets 3 different times according to the attitude where the apparatus body 2 is placed. In a case where the positional correction operation is to be performed multiple times according to the size of the printing sheet 3 or the attitude where the apparatus body 2 is placed, the approaching distances between the reference plate 41 and the lever guide plates 42 may be equal or different between/among the operations.

In a case where the positional correction operation is to be performed on each of the printing sheets 3 multiple times, the control section 86 may change the final correction position on each of the printing sheets 3 for each predetermined number of sheets. Thus, the repetitive friction between the thermal head 30 and the printing sheets 3 can be prevented.

Having described the printer apparatus 1 having two lever guide plates 42 in the direction of transfer of the printing sheets 3 according to an embodiment of the invention, three or more lever guide plates 42 may be provided instead according to the invention. In this case, the number of the lever guide plates 42 is preferably an even number so as to evenly press the front and back across the center line C of the printing sheet 3 in the direction of transfer.

Having described the example where the invention is applied to a heat-sensitive thermal head printer, the invention is also applicable to a dye-sublimation or fusion thermal head printer or an inkjet printer that forms an image by discharging ink to the printing sheets 3, for example.

The invention is not limited to the examples above but may be widely applied to a liquid discharging apparatus that forms an image, for example, by discharging liquid to a sheet. For example, the invention may also be applied to a facsimile machine, a copier, a discharging apparatus for a DNA chip in liquid (JP-A-2002-253200), or a liquid discharging apparatus, for example, that discharges liquid containing conductive grains for forming a wiring pattern on a printer wiring substrate.

It should be understood by those skilled in the art that various modifications, combinations, sub-combinations and alterations may occur depending on design requirements and other factors insofar as they are within the scope of the appended claims or the equivalents thereof.

What is claimed is:

1. A printer apparatus comprising:
transfer means for transferring a sheet;
printing means for printing on the sheet;
correcting means for correcting the position of the sheet to be transferred to the printing means, the correcting means having
a reference plate functioning as a reference for correcting the position of the sheet and supporting one side edge of the sheet, and
lever guide plates facing against the reference plate and each having
a supporting member rotatably supported substantially in orthogonal to the direction of transfer of the sheet and in point-contact with the other side edge of the sheet, and
an urging member urging the supporting member to the reference plate side;
moving means for moving the reference plate and the lever guide plates toward/away from each other;
control means for controlling the moving means; and
transfer position detecting means for detecting that the sheet has been transferred to a corrected position by the correcting means,
wherein the control means changes the space between the reference plate and the lever guide plates, which support both side edges of the sheet transferred to the corrected position in a range equal to or shorter than the width of the sheet.

2. The printer apparatus according to claim 1, wherein the sheet is transferred to the printing means after performing a positional correction operation by the reference plate and the lever guide plates on the sheet multiple times.

3. The printer apparatus according to claim 2, wherein correction operations have different approaching distances between the reference plate and the lever guide plates from each other.

4. The printer apparatus according to claim 2 or 3, wherein the number of times of positional correction operation depends on the size of the sheet.

5. The printer apparatus according to claim 2 or 3, wherein the number of times of positional correction operation depends on the attitude where the apparatus body is placed.

6. The printer apparatus according to any one of claims 1 to 5, wherein two lever guide plates are adjacent to each other along the direction of the transfer of the sheet, and the center of the sheet in the direction of the transfer is positioned between the supporting members.

7. The printer apparatus according to any one of claims 1 to 6, wherein the reference plate and the lever guide plates are moved away from the sheet before the sheet is transferred to the printing means after the end of the positional correction operation.

8. The printer apparatus according to any one of claims 1 to 7, wherein the approaching distances between the reference plate and the lever guide plates differ between the printing operation on one sheet and the printing operation on the another sheet is to be printed in a case where multiple sheets in one equal size are to be printed.

9. The printer apparatus according to claim 8, wherein the approaching distance between the reference plate and the lever guide plates is changed periodically.

10. The printer apparatus according to claim 9, wherein the approaching distance between the reference plate and the lever guide plates is changed for every predetermined number of sheets to be printed.

11. The printer apparatus according to claim 8, wherein the approaching distance between the reference plate and the lever guide plates depends on the attitude where the apparatus body is placed.

12. The printer apparatus according to claim 8, wherein the energization area of the printing means is changed based on the approaching distance between the reference plate and the lever guide plates.

13. A method for correcting the position of a sheet in a printer apparatus including:
transfer means for transferring a sheet;
printing means for printing on the sheet;
correcting means for correcting the position of the sheet to be transferred to the printing means, the correcting means having
a reference plate functioning as a reference for correcting the position of the sheet and supporting one side edge of the sheet, and
lever guide plates facing against the reference plate and each having
a supporting member rotatably supported substantially in orthogonal to the direction of transfer of the sheet and in point-contact with the other side edge of the sheet, and
an urging member urging the supporting member to the reference plate side;
moving means for moving the reference plate and the lever guide plates toward/away from each other;
control means for controlling the moving means; and
transfer position detecting means for detecting that the sheet has been transferred to a corrected position by the correcting means,
wherein the control means controls the moving means to change the space between the reference plate and the lever guide plates, which support both side edges of the sheet transferred to the corrected position in a range equal to or shorter than the width of the sheet.

14. A printer apparatus comprising:
a transfer section configured to transfer a sheet;
a printing section configured to print on the sheet;
a correcting section configured to correct the position of the sheet to be transferred to the printing section, the correcting section having
a reference plate functioning as a reference for correcting the position of the sheet and supporting one side edge of the sheet, and
lever guide plates facing against the reference plate and each having
a supporting member rotatably supported substantially in orthogonal to the direction of transfer of the sheet and in point-contact with the other side edge of the sheet, and
an urging member urging the supporting member to the reference plate side;
a moving section configured to move the reference plate and the lever guide plates toward/away from each other;
a control section configured to control the moving section; and
a transfer position detecting section configured to detect that the sheet has been transferred to a corrected position by the correcting section,
wherein the control section changes the space between the reference plate and the lever guide plates, which support both side edges of the sheet transferred to the corrected position in a range equal to or shorter than the width of the sheet.
